(19) United States
(12) Patent Application Publication
(10) Pub. No.: US 2005/0239411 A1
(43) Pub. Date: Oct. 27, 2005

(54) Method and apparatus to distribute statistics in a wireless communication network

(76) Inventors: Mousumi M. Hazra, Beaverton, OR (US); W. Steven Conner, Hillsboro, OR (US); Jing Zhu, Seattle, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/879,766

(22) Filed: Jun. 28, 2004

Related U.S. Application Data
(63) Continuation-in-part of application No. 10/816,434, filed on Mar. 31, 2004.

(51) Int. Cl. H04B 7/00

(52) U.S. Cl. 455/67.11; 455/69

(57) ABSTRACT

Apparatuses and methods to distribute statistics in a wireless communication network are described.

### RELATED APPLICATIONS

This Application is a Continuation-In-Part of U.S. patent application Ser. No. 10/816,434 titled “Self-Configuring Physical Carrier Sensing Threshold Adaptation” filed on Mar. 31, 2004, which is hereby incorporated by reference in its entirety.

### BACKGROUND

A wireless network may use statistics collected by an individual station to increase performance of the individual station. For example, in carrier sensing multiple access/collision avoidance (CSMA/CA) based wireless networks such as the Institute of Electrical and Electronics Engineers (IEEE) standard 802.11 networks, a transmitter may rely on carrier sensing to determine if the radio frequency (RF) medium is available to reduce interference. With carrier sensing, a station samples the energy level in the RF before starting a packet transmission, and a transmission is only started if the reading is below a threshold P_{cs}, also called the physical carrier sensing (PCS) threshold. Samples derived from a single station, however, may not provide an appropriate PCS threshold since it may not reflect conditions for surrounding stations. Consequently, there may be a need for improvements in such techniques in a device or network.

### BRIEF DESCRIPTION OF THE DRAWINGS

FIG. 1 is one embodiment of links between elements of a network.

FIG. 2 is one embodiment of a network element transmitting adaptation information to other elements of a network.

FIG. 3 is one embodiment of a block diagram of an adaptation loop.

FIG. 4 is one embodiment of an adaptation indicator step function.

FIG. 5 is one example of simulation results of throughput versus threshold level for one embodiment of an adaptive PCS system.

FIG. 6a is one example of results of dynamic threshold level versus time for a simulation of one embodiment of the invention.

FIG. 6b is one example of simulation results of throughput versus time for the simulation of FIG. 6a.

FIG. 7a is one example of simulation results of throughput versus time for one embodiment of an adaptive PCS threshold system.

FIG. 7b is one example of simulation results of dynamic threshold level versus time for the simulation of FIG. 7a.

FIG. 8 is one embodiment of a block diagram of a device having circuit elements to perform dynamic PCS adaptation.

FIG. 9 is another embodiment of a block diagram of a device having circuit elements to perform dynamic PCS adaptation.

FIG. 10 is one embodiment of a control frame to communicate information between nodes in a network.

FIG. 11 is one embodiment of a timing diagram to communicate a control frames between nodes in a network.

FIG. 12 is one embodiment of programming logic to communicate information using a control frame.

### DETAILED DESCRIPTION

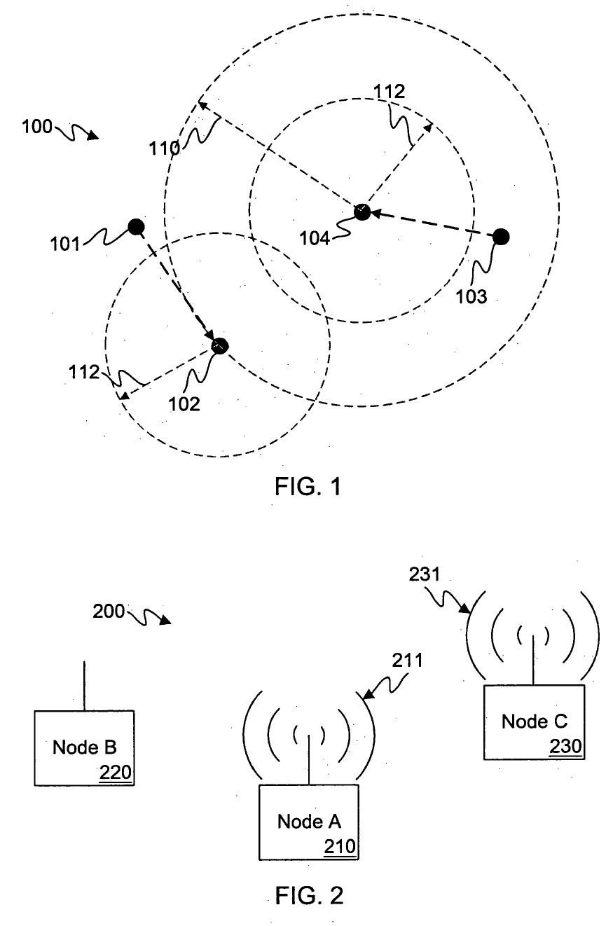

FIG. 1 illustrates a network 100. Network 100 may comprise, for example, a communication system to communicate information between multiple nodes. The nodes may comprise any physical or logical entity having a unique address in network 100. The unique address may comprise, for example, a network address such as an Internet Protocol (IP) address, device address such as a Media Access Control (MAC) address, and so forth. The embodiments are not limited in this context.

The nodes may be connected by one or more types of communications media. The communications media may comprise any media capable of carrying information signals, such as metal leads, semiconductor material, twisted-pair wire, co-axial cable, fiber optics, radio frequency (RF) spectrum, and so forth. The connection may comprise, for example, a physical connection or logical connection.

The nodes may be connected to the communications media by one or more input/output (I/O) adapters. The I/O adapters may be configured to operate with any suitable technique for controlling communication signals between computer or network devices using a desired set of communications protocols, services and operating procedures. The I/O adapter may also include the appropriate physical connectors to connect the I/O adapter with a given communications medium. Examples of suitable I/O adapters may include a network interface card (NIC), radio/air interface, and so forth.

The general architecture of network 100 may be implemented as a wired or wireless system. If implemented as a wireless system, one or more nodes shown in network 100 may further comprise additional components and interfaces suitable for communicating information signals over the designated RF spectrum. For example, a node of network 100 may include omni-directional antennas, wireless RF transceivers, control logic, and so forth. The embodiments are not limited in this context.

The nodes of network 100 may be configured to communicate different types of information, such as media information and control information. Media information may refer to any data representing content meant for a user, such as voice information, video information, audio information, text information, alphanumeric symbols, graphics, images, and so forth. Control information may refer to any data representing commands, instructions, control words, or statistical information meant for an automated system. For example, control information may be used to route media information through a system, instruct a node to process the media information in a predetermined manner, or assist a node in operating in a certain operating environment, and so forth.

The nodes may communicate the media and control information in accordance with one or more protocols. A protocol may comprise a set of predefined rules or instructions to control how the nodes communicate information between each other. The protocol may be defined by one or more protocol standards, such as the standards promulgated by the Internet Engineering Task Force (IETF), International Telecommunications Union (ITU), the Institute of Electrical and Electronics Engineers (IEEE), a company such as Intel® Corporation, and so forth.

In one embodiment, the nodes may communicate control information using a new protocol as described herein, referred to as the Network Statistics Protocol (NSP). The control information may comprise, for example, information comprising one or more statistics as measured by a node in the network. NSP may be used to disseminate the control information throughout the nodes of a network. NSP may attempt to reduce bandwidth demands on the network by communicating such information in the form of relatively small, lightweight packets. In one embodiment, for example, the packets do not have the added overhead of source address tagging and/or identification of the source of the control information. NSP assumes that each node in a network maintains one or more local statistics of interest, where a statistic Sₙ can be encoded using n bits, such that 0 Sₙ 2ⁿ. NSP may be used to support both direct statistics collection from unicast or multicast neighbors and neighborhood statistics estimation.

In one embodiment, NSP may be used to communicate control information in support of an adaptive PCS system, as described in detail below with reference to FIGS. 1-11. It may be appreciated, however, that NSP may be used to communicate any type of control information in support of any number of applications. The embodiments are not limited in this context.

Referring again to FIG. 1, network 100 may comprise nodes 102, 103 and 104, and some links between such nodes. Specifically shown are links between node 101 and node 102, and node 103 and node 104, over which the various nodes may communicate to each other. As shown in FIG. 1, a network node may generate a signal to transmit to an intended node. The signal for the intended node, however, may also be detected by unintended receivers. This may disrupt communications by the unintended receiver. For example, a signal transmitted by node 101 to intended receiver node 102 may interfere with the ability of node 104 to successfully receive a communication from node 103. Interference may thus limit the ability of elements of a system to communicate with each other.

The characteristics of the physical layer of the network elements will cause limitations on what may be considered to be a tolerable level of interference over which a receiver will be able to successfully receive communications. In a CSMA/CA system, elements of the network typically determine a signal to noise ratio (SNR) of a link prior to transmission over the link. Specifically a signal to noise plus interference ratio (SNIR) may be used to account for other transmissions within the same transmit space. If the level of interference on the link is below a threshold, the node will determine that transmission is permissible, whereas if the interference level is above the threshold, the node may be required to back off and wait prior to transmission. As part of the process of determining whether transmission is permissible, a node will typically make a measurement referred to as the carrier sense threshold, or CS. The CS is the fundamental radio channel measurement made prior to transmission to determine if collision will be avoided. Various schemes, for example, virtual CS (VCS), may be based off the CS. To distinguish possible various other schemes for determining the ability to transmit, the term physical carrier sense (PCS or P_{CS}) will be used herein to refer to the fundamental radio channel measurement.

Note that system 100 is shown with nodes 101-104 in various locations with respect to each other. System 100 may be a mesh network, in which elements of the network are spread across a two dimensional space. In a mesh network elements may communicate with a neighboring node, and communication to non-neighboring nodes is generally accomplished by communicating to a neighbor, which communicates with another neighbor, etc., until the intended node is reached. System 100 may also be a chain network, with elements essentially linearly arranged, and each node communicates only with the two neighboring nodes, and communication to non-neighboring nodes occurs via relay from one neighboring node to another. Thus, element arrangement of system 100 is not limited to a particular configuration. In one embodiment, network 100 is an 802.11 compliant CSMA wireless local area network (WLAN).

Note that various situations may result in system 100 based upon the selection of a PCS threshold. In a first situation the threshold may be selected to be overly sensitive, causing CSMA to be too conservative. The conditions of a PCS threshold that is too sensitive is that CSMA will prevent simultaneous transmissions that would be permitted by the physical layer receiver characteristics. For example, suppose that PCS threshold 110 centered on node 104 represents a threshold level that is overly sensitive. It may be overly sensitive because a transmission from node 101 to node 102 would produce interference that would not disrupt a communication on the link between nodes 103 and 104, and yet transmission would be prevented because the interference is above a selected threshold 110. Thus, although successful communication on the link between nodes 103 and 104 is possible, when node 104 detects the signal strength of the transmission between nodes 101 and 102 above threshold 110, it is required to wait for the transmission medium to become available prior to communicating with node 104. To maximize system throughput, CSMA should permit the communication on the link between nodes 103 and 104, because the signal strength on the link would be acceptably high enough to distinguish the communication from interference resulting from the transmission on the link between nodes 101 and 102.

In a second situation the threshold may be selected to not be sensitive enough, causing CSMA to be overly aggressive. The conditions of a system with a PCS threshold that is not sensitive enough is that CSMA will allow transmission on links where communication will be disrupted by interference from other signals in the transmit space. Thus, the system will have an unacceptable incidence of collision. For example, consider a threshold 112 centered on receiving nodes 102 and 104. Assume that threshold 112 represents a PCS threshold level that is not sufficiently sensitive. Suppose that nodes 103 and 104 initiate a communication on their link, and that the transmissions will interfere with the ability of node 102 to successfully receive signals from node 101. Because threshold 112 is not sensitive enough, when node 102 performs carrier sensing, although it may detect interference from the link between nodes 103 and 104, the interference signal strength is lower than the threshold level. Thus, nodes 101 and 102 may attempt to engage in transmission, which will result in collision at receiving node 102. In this situation, system throughput may actually be improved by having nodes 101 and 102 back off and wait for transmission between nodes 103 and 104 to terminate prior to communicating.

In a third situation the PCS threshold level has the appropriate level of sensitivity, causing CSMA to result in maximum system throughput for system 100 by achieving maximal spatial reuse without permitting collision. Suppose now that threshold 112 represents an optimal threshold level, meaning it is characterized by permitting transmission where the interference levels at receiving nodes are acceptable to achieve successful transmission without collision, and by causing a node to back off from transmission where interference levels would be sufficient to disrupt successful communication. Note that optimal threshold may not necessarily mean an absolute optimum, and may not result in absolute spatial reuse. That is, consider a receiving node (not shown) that is located somewhere between nodes 102 and 104. A transmission from node 101 to node 102 may disrupt communication to a receiving node located between nodes 102 and 104, and yet not disrupt communication at receiving node 104. Thus, the optimal threshold level will allow communication on the link between nodes 101 and 102, and yet may require a receiving node between nodes 102 and 104 to back off.

In one embodiment system 100 is designed to utilize dynamic PCS threshold adaptation. In an ideal system, an optimal PCS threshold may be pre-selected for all elements of the network, and CSMA would maximize spatial reuse to maximize system throughput based on the pre-selected threshold. In a real system, no fixed PCS threshold can adequately match the system to every operating condition of the network. As shown above, when a PCS threshold is too sensitive, nodes will back off that should transmit. Also, when a PCS threshold is not sensitive enough, nodes will transmit that should back off. With system 100 able to dynamically monitor and adjust the PCS threshold, the threshold could be made to track changes in the operating environment of system 100. This would result in better system throughput.

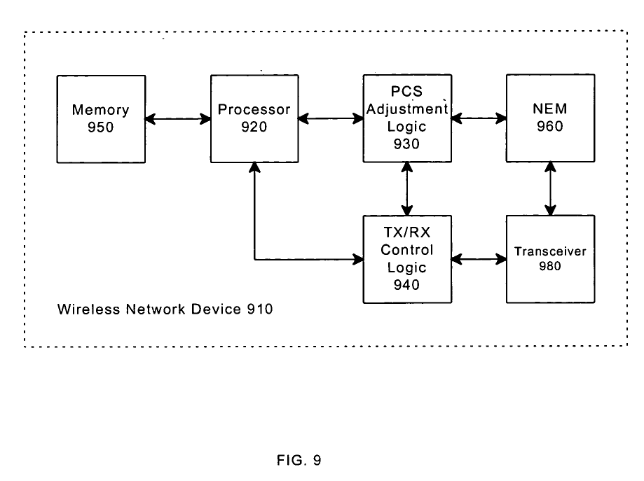

FIG. 2 is one embodiment of a network element transmitting adaptation information to other elements of a network. System 200 includes node A 210, node C 230, and node B 220. Node A 210 is capable of measuring and/or determining local transmit/receive characteristics and/or statistics for a communication channel over which node A 210 will communicate. Characteristics may include, but are not limited to, an SNR of the communication channel, which may include SNIR, PCS threshold level, an adaptation indicator, etc. Node A 210 transmits information 211 related to the measured characteristics to other nodes in system 200. For example, node A 210 may broadcast the characteristics to neighboring nodes, or transmit to selected nodes, etc. A neighboring node is one within range of detecting and correctly receiving the signal having the information. Communication of the transmit/receive characteristics and/or statistics for a communication channel between neighboring nodes may be accomplished using NSP, as discussed in more detail with reference to FIGS. 9-12.

In one embodiment node A 210 transmits information 211 for other nodes in the network to receive. Node C 230 may receive the information 211. Node C 230 may also transmit information 231, which would be received by node A 210. Each node measures its own characteristics for its communication channel and may determine an adaptation indicator for the local node. An adaptation indicator may include a variable, one or more flags, etc., to indicate that the node has determined its own threshold to need adjusting. It may then determine based on the information received from the neighboring node and its own adaptation indicator whether to adjust its local PCS threshold, and if it is to be adjusted, a value to which to adjust it. Thus, node A 210 will measure and determine statistics for node A 210 and transmit them to node C 230. Node A 210 will receive statistics transmitted by node C 230, and determine based at least in part on the information 231 received from node C 230 how to adjust the PCS threshold local to node A 210, if at all. Node C 230 will perform a similar process. In this way the setting of optimal PCS thresholds at the nodes of system 200 occurs in a distributed fashion, because each node individually makes a determination at its node. The local determinations provide system 200 with a global optimal performance based on the fact that each local node A 210 and C 230 will have a PCS threshold set for maximizing throughput. The throughput of the system at large will then be maximized.

The process above is described in terms of node A 210 and node C 230, but may also be applicable to node B 220. In one embodiment node B 220 has the ability to monitor its local characteristics and transmit the characteristics to other nodes in system 200. Node B 220 may then follow a similar process as described above in determining a local optimal PCS threshold.

In an alternate embodiment, both node A 210 and node C 230 may transmit information to a single node B 220. A single node for gathering and/or processing adaptation information may be referred to as a central monitoring node, or central node. Use of a central node means that some or all nodes in the system transmit information to the central node. Thus, rather than the purely distributive embodiment above, one node may be partially or wholly responsible for collecting information related to dynamic PCS threshold adaptation. For example, if node B 220 were a central node, node A 210 and node C 230 may transmit only to node B 220 rather than to each other. Central node B 220 may then process and/or relay the information to other nodes in system 200.

Central node B 220 may simply gather and transmit information for other nodes, or it may gather and perform some processing of information prior to sending a signal to the other nodes. For example, node B 220 as a central node may select a PCS threshold value for nodes in system 200, or determine a global PCS threshold for all neighboring nodes. Node B 220 may then transmit a message to cause the nodes in system 200 to adjust their PCS threshold, or simply transmit the value to the nodes. Alternatively, node B 220 may determine from among the information received, which values are within a specific range, or which are the lowest, etc., and relay such determined information to other nodes. Generally systems are designed to be homogenous in that all nodes share a common PCS threshold level.

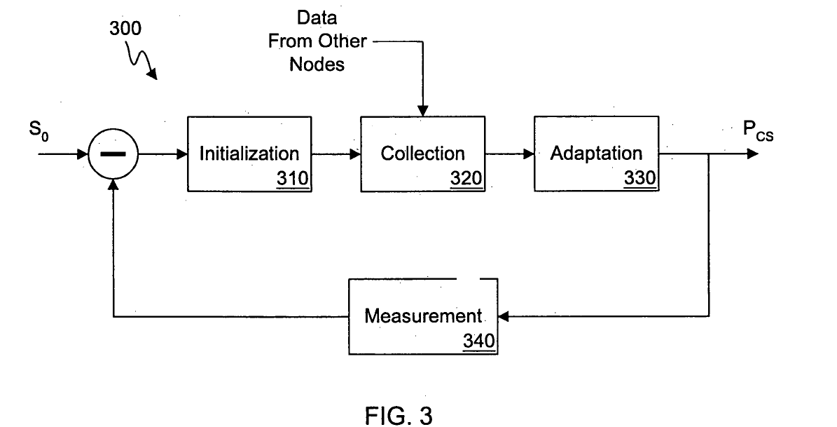

FIG. 3 is one embodiment of a block diagram of an adaptation loop. Processes of adaptation loop 300 may be performed locally at each station in the system, or the process or equivalent may be performed at a central station. In another embodiment, certain processes are performed at the local station while other processes are performed at a central station.

Each station in the system is presumed to be able to perform local characteristic gathering, shown by measurement 340. This includes, but is not limited to determining an interference condition of a selected communication channel, determining local transmission limitations, etc. For example, in CSMA systems an SNIR measurement is made by a local station prior to transmission on a communication channel. This measurement is compared against a reference level S₀, such as a level specified by the physical layers of the station's transmission system.

From the data determined by measurement 340, a station determines at initialization 310 a local PCS threshold. The local PCS threshold level will account for the limitations of the physical layer in transmitting into the environment of the communication channel. Based on the characteristics determined for the communication channel and the physical layers of the station, an adaptation indicator ξ may be determined. The adaptation indicator ξ, to be discussed in more detail below, is an indicator as to whether the local station should adjust its currently set PCS threshold. One embodiment of determining an adaptation indicator ξ may be according to the following mathematical function:

$$ξ = \{ \begin{matrix}2 , & & \overline{S} \geq {S}_{0} + δ \\ 1 , & if & {S}_{0} - δ < \overline{S} < {S}_{0} + δ , \\ 0 , & & \overline{S} \leq {S}_{0} - δ\end{matrix}$$

where \overline{S} represents a measured value of the threshold, S₀ represents a reference value of the threshold, and δ is some value, e.g., 0.5 dB, 1.0 dB, 2.0 dB, which indicates the range of tolerance allowed for the threshold in the particular system implementation. Alternatively, the adaptation indicator ξ may have different values, or values may correspond to different functions. It is also conceivable to use a pair of logical flags such as one to indicate that a change should take place, and a second to indicate whether the change will be to increase or decrease the value of the PCS threshold. The output of initialization 310 may include a local PCS value and an adaptation indicator ξ.

The station knows the local current PCS threshold and the determined adaptation indicator ξ, and further gathers characteristics from other stations in collection 320. Collection 320 represents the station receiving the characteristics of neighboring stations as shown by data from other stations being received into collection 320. This data may include a PCS threshold value and adaptation indicator determined by each station locally, and transmitted to the station for which adaptation loop 300 is being performed. The data may be received directly, as in a distributed adaptation system, or from a central station, as in a centralized network configuration.

Based on the information gathered for the local station as well as the other stations in the system, a determination may be made as to whether to adjust the local PCS threshold. The information may be processed in a centralized or distributed fashion to make the determination. In one embodiment the processing involves a simple lowest threshold determination from among the data gathered from the local station and the neighboring stations, as in the following mathematical functions:

$$ξ = min ( x , ξ )$$

$${P}_{C}^{( min )} = min ( y , {P}_{C}^{( min )} ) .$$

where ξ represents the adaptation indicator, min( ) is the minimum function, and P_{C}^{(min)} represents the minimum PCS value, x represents the value of ξ for other station(s) received in collection 320, and y represents the value of P_{C}^{(min)} for other station(s) received in collection 320.

In this case a minimum value is determined and the PCS threshold is set to match the minimum value found. This is one method to maximize fairness. If a particular station in the system is operating under conditions of greater interference than other stations, its threshold may be required to be more sensitive in order to successfully complete transmissions. While neighboring stations may be able to support a less sensitive threshold, if the neighboring stations were to set their PCS thresholds to less sensitive values, the station requiring the more sensitive threshold due to its operating environment would be less likely able to transmit. In the case where all values are set to the same lowest value, all stations in the system will back off or transmit according to the same threshold. Thus, a station would not have a more aggressive neighbor that prevents it from transmitting. Other methods may include determining a value that is within a window, or closest to a certain value, etc.

Once a local optimal PCS threshold is determined, the PCS threshold is set in adaptation 330. In one embodiment the PCS threshold is value that may be set directly to a value. Alternatively, the PCS threshold may be adjustable only in steps. A combination may be used, where a PCS threshold value is determined, and the value set may be adjusted by some step δ. One example of a possible mathematical function is:

$${P}_{cs} = \{ \begin{matrix}{P}_{cs}^{( min )} + δ , & & ( ξ = 2 ) \\ {P}_{cs}^{( min )} , & if & ( ξ = 1 ) , \\ {P}_{cs}^{( min )} - δ , & & ( ξ = 0 )\end{matrix}$$

where P_{CS} represents the PCS threshold value, P_{C}^{(min)} represents a minimum PCS threshold determine, δ represents an incremental step of PCS, and ξ represents the adaptation indicator.

Note that each of the above equations represents a function for each individual station in the system. The function being performed for each station based on information received from other stations results in determining a global optimal value for the system that will result in maximum throughput based on PCS value for the system. This global optimal value will most often allow stations to transmit, and do so in a fair manner. Thus, every station will take maximum fair opportunities to transmit.

In one embodiment aspects of dynamic PCS adaptation are performed on a periodic basis. For example, the system may have some τ defined as a time period. At the beginning/end of each period τ the station may adjust its PCS threshold settings. The value of τ will depend upon the system, and may be, e.g., 0.5 sec, 1.0 sec, 2.0 sec, etc. Note that the setting of the PCS threshold in adaptation 330 is only one process in adaptation loop 300. Other parts of loop 300 may occur during the time interval, and may occur behind the scenes so as to be non-disruptive on system processing resources. Thus, one implementation would have collection 320 occur whenever a packet is received from other system nodes that includes adaptation characteristics. A determination may be made when the packet is received as to what the best value of P_{CS} and ξ should be. Determinations as to local measurements may be made periodically, (every τ seconds), or only when a communication is to take place with another station.

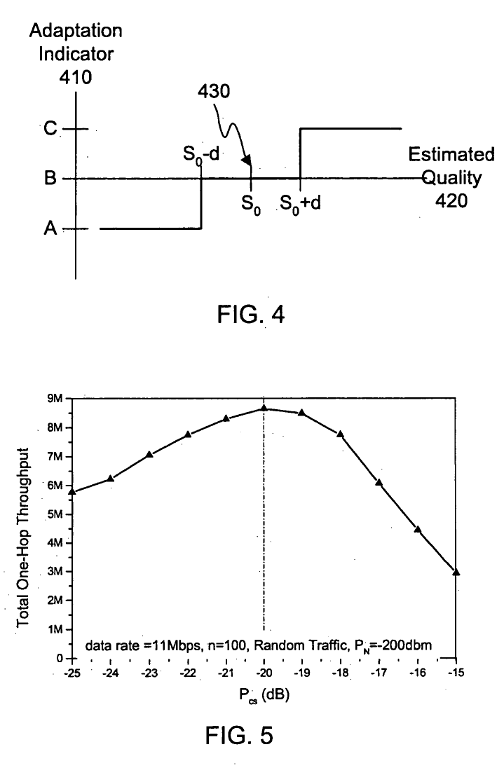

FIG. 4 is one embodiment of an adaptation indicator step function. In a system performing adaptive PCS threshold adjustment, a determination is made for each node in the system as to whether its current threshold is optimal for the node in the interference condition, or whether the threshold needs to be adjusted. This information is shared with neighboring nodes according to the techniques described above. Based upon the information from local measurements, and the information shared from neighboring nodes, the node may adjust its PCS threshold.

As shown in FIG. 4, an adaptation indicator 410 is assigned a value A, B, or C based on an estimated quality 420. One example of this is given by the equation, repeated from above:

$$ξ = \{ \begin{matrix}2 , & & \overline{S} \geq {S}_{0} + δ \\ 1 , & if & {S}_{0} - δ < \overline{S} < {S}_{0} + δ \\ 0 , & & \overline{S} \leq {S}_{0} - δ\end{matrix}$$

where ξ represents adaptation indicator 410, \overline{S} represents estimated quality 420, S₀ represents a reference threshold, and δ (or d) represents an incremental value.

Adaptation indicator 410 ξ is set to a value of B if an estimated quality 420 \overline{S} is within a range of acceptable estimated quality. The acceptable estimated quality range is some reference quality S₀, plus or minus a factor d. The value of d is dependent upon the implementation desired, and can be determined based upon experimentation. For example, d may be 0.5 dB, 1.0 dB, 0.75 dB, etc. d may be selected to be a small enough or a large enough step to allow the system to keep a fine tune around S₀, or allow a little more noise. This will depend on the capabilities of the system hardware, as well as the environment under which the system is operating.

The value of adaptation indicator 410 ξ may be set to a value of C if estimated quality 420 \overline{S} is above a threshold S₀+d. The value of adaptation indicator 410 ξ may be set to a value of A if estimated quality 420 \overline{S} is below a threshold S₀−d.

FIG. 5 is one example of simulation results of throughput versus threshold level for one embodiment of an adaptive PCS system. The simulated adaptive PCS system consisted of a 10×10 homogenous 802.11 grid network operating according to embodiments of the invention described herein. Specifically, each network element could measure local PCS and local adaptation statistics and broadcast them to neighboring network elements. Each element in the network received the statistics from neighboring elements, and adjusted its local PCS threshold according to the most sensitive PCS threshold from among the neighboring network elements. The simulation in FIG. 5 has the further characteristics of an 11 Mbps data rate, a background noise value (P_{N}) of −200 dbm, and γ (path loss exponent) of 2.5. The simulation shows a maximum throughput at a PCS threshold of −20 dB. The theoretical optimal PCS threshold for the system simulated in FIG. 5 is −21 dB. This shows that a system using dynamic, distributed PCS threshold adjustment is capable of tracking a theoretical optimal value quite closely.

Also note the difference in throughput the PCS threshold makes. A plus or minus 2 dB value drops the throughput by over 10%. The further away the PCS threshold is from the optimal value, the worse the results. Therefore, it is concluded that choosing the appropriate PCS threshold makes a significant difference in terms of throughput performance.

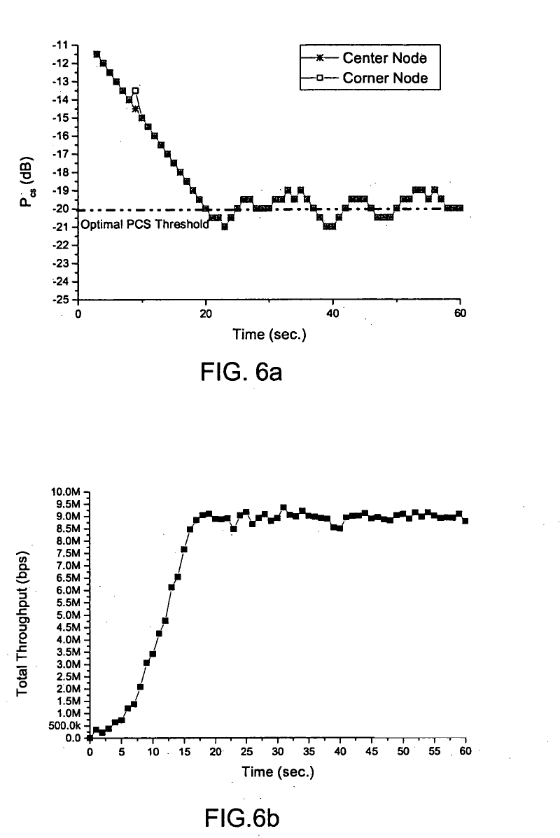

FIG. 6a is one example of simulation results of dynamic threshold level versus time for one embodiment of an adaptive PCS system. The simulated system is the same system simulated in FIG. 5. In this example, the PCS threshold was started at an arbitrary value that was not very sensitive. The system was allowed to dynamically “find” an optimal PCS threshold for the system. It is important to note that in this simulation, the PCS value was updated at each element at one second intervals. It took less than 20 seconds from an arbitrarily insensitive PCS threshold for the system to achieve a system threshold within 1 dB of the optimal PCS threshold. The system then tracked the optimal threshold within 1 dB.

FIG. 6b is one example of simulation results of throughput versus time for the simulation of FIG. 6a. The results of this simulation show throughput over the same time interval of FIG. 6a. Throughput began at a very low value, but maximized as the system achieved the optimal PCS threshold. Note that the throughput, as with the PCS threshold of the above simulation reached a stable level. This again confirms a relationship between PCS threshold and system throughput.

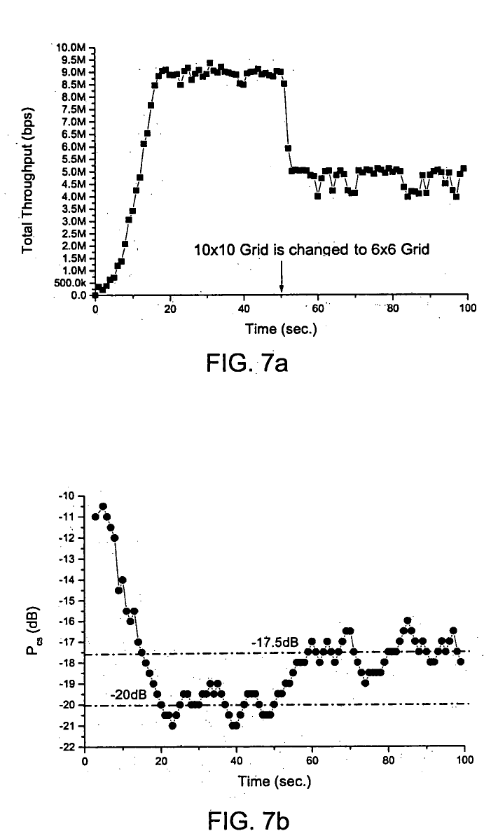

FIG. 7a is one example of simulation results of throughput versus time for one embodiment of an adaptive PCS threshold system. Consider the system simulated in FIGS. 6a and 6b. To further illustrates the effect of adaptation, the effective topology of the simulated system is changed in the middle of the simulation period such that only stations in a 6×6 grid in the center of the 10×10 grid will continue to generate traffic, while all other stations stop after 50 seconds. FIG. 7a shows how the simulated system achieved a stable throughput level, and was then required to adapt. The total throughput decreases because of the reduced total number of active stations.

FIG. 7b is one example of results of dynamic threshold level versus time for the simulation of FIG. 7a. Just as the system achieved its optimal PCS threshold with the 10×10 grid, when the network topology was changed to the center 6×6 grid, the system had to achieve a new optimal PCS threshold level. The PCS converges to its new value of −17.5 dB.

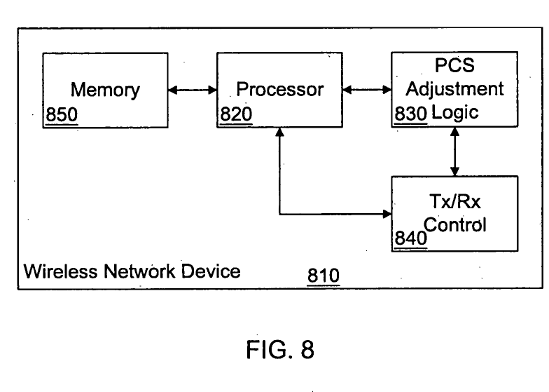

FIG. 8 is one embodiment of a block diagram of a device having circuit elements to perform dynamic PCS adaptation. Wireless electronic device 810 may be implemented in any wireless device, such as wireless nodes A-C described with reference to FIG. 2. Wireless electronic device 810 is an example of a device that may be part of a wireless network that performs according to the CSMA standard. Device 810 include processor 820 that may be a StrongARM® processor by Intel Corporation of Santa Clara, Calif., a digital signal processor (DSP), or other type of microprocessor for use in wireless electronic systems. Processor 820 executes instructions and performs functions that may be considered to be processing, such as determining values, performing comparisons, searching, determining minimum values, etc. Processor 820 may receive instructions from memory 850. Processor 820 may also interchange data with memory 850 to manipulate the values of variables, or perform processing on certain data, etc.

Because wireless electronic device 810 operates an adaptive PCS scheme, device 810 includes some sort of PCS adjustment logic 830. PCS logic 830 may include the circuits that set the hardware PCS threshold level to its desired value. In one embodiment PCS logic 830 may be considered to be part of processor 820, and perform functions such as generating one or more signals to cause transmit/receive hardware to adjust the PCS threshold.

In another embodiment part or all of PCS logic 830 may be considered to be part of transmit/receive (Tx/Rx) control 840, which may include the hardware and/or circuits directly responsible for the PCS threshold level. Tx/Rx control 840 may interact with PCS logic 830 and/or processor 820 in the adaptation processes where the PCS threshold is adjusted, as well as in the measurement processes where characteristics data is gathered for device 810. Tx/Rx control 840 may include the logic and/or hardware to make a determination of the conditions of the communication channel and the physical layers of device 810.

Device 810 includes memory 850 for storing instructions and/or data. Memory 850 may include one or more of flash, synchronous dynamic random access memory (SDRAM), read-only memory (ROM), etc. The instructions/data stored in memory 850 may include instructions/data directed to performing dynamic PCS adaptation. These instructions/data may be stored on memory 850 from preprogramming of the memory device, or from loading instructions/data onto memory 850 from another article of manufacture. An article of manufacture refers herein to some medium capable of storing and/or transmitting digital content to a memory. For example, an article of manufacture may include a disk, whether magnetic, optical, electronic, etc., a transmission medium to transmit digital content, such as cables, wires, etc., or a portable memory device, such as memory cards, sticks, etc.

FIG. 9 is another embodiment of a block diagram of a device having circuit elements to perform dynamic PCS adaptation. FIG. 9 may illustrate a wireless network device 910 that is similar to wireless network device 810. For example, elements 820, 830, 840 and 850 may correspond in structure and operation to elements 920, 930, 940 and 950, respectively. In addition, wireless network device 910 may include a network estimate module (NEM) 960, and a transmitter/receiver (“transceiver”) 980.

In one embodiment, wireless device 910 may also include transceiver 980. Transceiver 980 may comprise a transmitter and a receiver, either implemented alone or in combination. The transmitter may comprise any transmitter system configured to transmit an electromagnetic signal, such as a RF signal at a desired operating frequency. The transmitter may comprise a transmitter antenna operatively coupled to an output stage. The output stage may comprise various conventional driving and amplifying circuits, including a circuit to generate an electric current. When the electric current is supplied to the transmitter antenna, the transmitter antenna may generate electromagnetic signals around the transmitter antenna at or around the operating frequency. The receiver may comprise any receiver system configured to receive RF signals from the transmitter at a predetermined operating frequency. For example, the receiver may comprise conventional amplifying and signal-processing circuits, such as band pass filters, mixers, and amplifier circuits. The receiver may receive the electromagnetic signals from a transmitter at the operating frequency, and convert the received signals to electric current/voltage for use by the other elements of device 910.

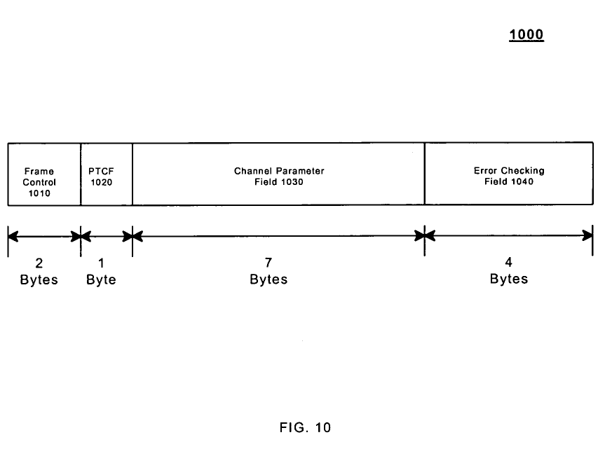

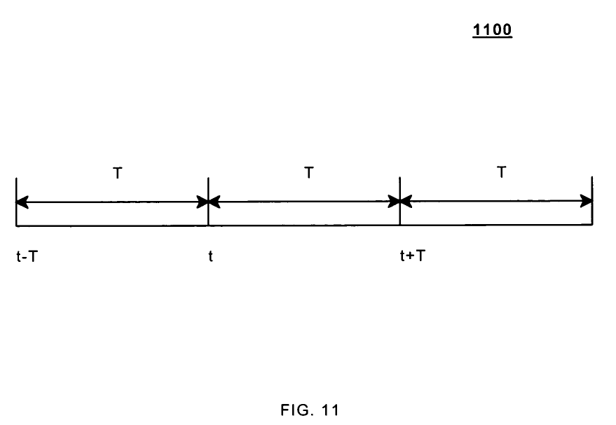

In one embodiment, wireless device 210 may include NEM 960. NEM 960 may be used to communicate information between multiple nodes, such as wireless nodes A-C. The information may comprise, for example, values or statistics representative of one or more characteristics for a wireless communication channel. Characteristics may include, but are not limited to, an SNR of the communication channel, which may include SNIR, PCS threshold level, an adaptation indicator, and so forth. NEM 960 may generate a control frame to communicate the values or statistics to various neighboring nodes. An example of a control frame generated by NEM 960 may be discussed in more detail with reference to FIG. 10.

FIG. 10 is one embodiment of a control frame to communicate information. NEM 960 may be arranged to operate in accordance with NSP. NSP may be used to disseminate information throughout nodes A-C of system 200. Further, NSP may attempt to reduce bandwidth demands associated with communicating such information by sending relatively small, lightweight packets, that do not have the added overhead of source address tagging and/or identification of the source of the communicated information. NSP assumes that each node A-C maintains one or more local statistics of interest, where a statistic Sn can be encoded using n bits, such that 0 Sₙ 2ⁿ. NSP may be used to support both direct statistics collection from unicast or multicast neighbors and neighborhood statistics estimation.

In one embodiment, NEM 960 may generate a control frame 1000. Control frame 1000 may comprise a new control frame for use with NSP or any conventional protocol, such as the 802.11 family of protocols, for example. Control frame 1000 may comprise a number of bytes similar to an 802.11 ACK packet, which is relatively small for a packet communicating control information. As shown in FIG. 10, control frame 1000 may comprise approximately 14 bytes of information, separated into four fields. Control frame 1000 may include a frame control field (FCF) 1010 comprising 2 bytes, a parameter type control field (PTCF) 1020 comprising 1 byte, a channel parameter field (CPF) 1030 comprising 7 bytes, and an error checking field (ECF) 1040 comprising 4 bytes. Although a limited number of fields and bytes may be shown for control frame 1000, it may be appreciated that the number of fields and bytes may vary according to a given implementation. For example, a first implementation may add additional fields to provide added operations, a second implementation may allocate the total number of available bytes differently, a third implementation may combine fields, and so forth. The embodiments are not limited in this context.

In one embodiment, control frame 1000 may include FCF 1010. FCF 1010 may be used to communicate header information for control frame 1000. For example, the header information may include a standard 802.11 header, which includes 16 bytes of information. An 802.11 header may include a Sub Type Field (STF) comprising 4 bytes. The STF may identify the remaining information for control frame 1000. For example, the STF may be set to indicate an NSP control frame (NSPCF). If a node such as nodes A-C is capable of recognizing and processing a NSPCF, then the rest of control frame 1000 may be processed accordingly. Otherwise, the node may drop control frame 1000 without disrupting normal operations. In this way, NSP may be integrated with legacy network elements. The type of and amount of header information is not limited in this context.

In one embodiment, control frame 1000 may include ECF 1040. ECF 1040 may be used to communicate error checking information. For example, the error checking information may comprise any information suitable for use with any error checking or correction algorithm, such as an error checking algorithm used by the 802.11 family of protocols. The type and amount of error checking information is not limited in this context.

In one embodiment, control frame 1000 may include PTCF 1020 and CPF 1030. PTCF 1020 may be used to communicate a channel type parameter. The channel type parameter may indicate a format for the 7 bytes of CPF 1030. CPF 1030 may be used to communicate the channel parameters. The channel parameters may include any number of different types of information in any number of different formats. For example, the channel parameters may include a channel parameter identifier, a channel parameter value, a network address, and so forth. The channel parameters may also include any number of combinations of the above. An example of a channel parameter identifier may comprise a unique identifier for the channel parameter value. An example of a network address may comprise a source address for the node measuring the encoded statistics.

In one embodiment, control frame 1000 may be used to communicate one or more “channel parameter values.” The term “channel parameter value” as used herein may refer to a value used to represent any type of characteristic or statistic for a node or its surrounding environment. For example, the channel parameter value may represent power consumption for a node, processing speeds for a node, idle time for a node, monitoring parameters for critical elements of a node, operating status, location, sensor outputs, and so forth. In another example, the channel parameter value may include channel characteristics for a node, such as a SNR, SNIR, local (PCS) threshold level for a node, a global PCS threshold level for a network or system, an adaptation indicator ξ, a contention window (CW) size, and so forth. The type and number of channel parameter values are not limited in this context.

An example of the various channel type parameters and channel parameters may be illustrated in Table 1.

TABLE 1

| | Channel | | |
|---|---|---|---|
| Channel Type | Parameter | Channel | Network |
| Parameter | Identifier | Parameter Value | Address |
| 0 | None | 7 bytes of encoded statistic | None |
| 1 | 1 Byte | 6 bytes of encoded statistic | None |
| 2 | None | 1 byte of encoded statistic | 6 bytes of |
| | | | source address |
| 3-255 | Reserved | Reserved | Reserved |

As shown in Table 1, the 7 bytes of CPF 1030 can be used as necessary for disseminating various statistics in a wireless network. When the channel type parameter is set to zero (0), all 7 bytes of CPF 1030 may be used to encode a default statistic type. When the channel type parameter is set to one (1), 1 byte of CPF 1030 may be used to identify the statistic type and the remaining 6 bytes may be used to encode the estimated statistic. This format may be used, for example, if more than one statistic is disseminated within the network. When the channel type parameter is set to two (2), 1 byte of CPF 1030 may be used to encode the estimated statistic and the remaining 6 bytes may be used for the source address of the node measuring or collecting the statistic. While this format may not be needed for collecting many neighborhood statistics, control frame 1000 may provide this option to increase the flexibility of NSP. With only 1 byte allocated for the channel type parameter, it can be appreciated that up to 256 different formats may be defined for a network. Although a few channel parameters are shown in Table 1 by way of example, it may be appreciated that any number of channel type parameters and channel parameters may be defined for a given implementation.

In general operation, a node such as nodes A-C may broadcast control frame 1000 using the CSMA/CA protocol. Other devices that support control frame 1000 will be able to extract the relevant statistics from control frame 1000, and use the statistic to estimate the state of the wireless neighborhood. Nodes A-C in the network can use statistics from other nodes in the network neighborhood in many different ways, including adaptation information for dynamic PCS adaptation, feedback for tuning MAC parameters such as contention window (CW) size to minimize collisions, metric computations for choosing multi-hop routes across a wireless network, and so forth. The embodiments are not limited in this context.

FIG. 11 is one embodiment of a timing diagram to communicate a control frames between nodes in a network. FIG. 11 illustrates a timing diagram 1100. In order to allow nodes to estimate the typical or average statistics values from the set of nodes in the local wireless neighborhood, each neighboring node is allowed to communicate its statistics value to the neighborhood no more than once in a fixed interval of time. A periodic time interval of duration T is defined, as shown in timing diagram 1100. The length of this interval is fixed across all nodes in the wireless network, although each clock used by the various nodes does not necessarily need to be synchronized across the network. During each periodic time interval of duration T, each node builds the value of the local statistics of interest Sₙ(T_current) that it will share with neighbors after the interval. At the end of each time interval, a node keeps a copy of Sₙ(T_current) as a value to report to neighbors during the next interval. The copy may be represented as Sₙ(T_report)=Sₙ(T_current). The node may then reset Sₙ(T_current) to start gathering a new instance of Sₙ(T_current). At the end of interval T, each node may use CSMA/CA to broadcast a control frame 1000 with the statistics information encoded in CPF 1030, where the statistic will be represented using n bits, and where the last recorded statistic at the node is S 2ⁿ.

When a node receives a control frame from a neighboring node, the node may retrieve the statistic from CPF 1030 and process the retrieved statistic for a specific application, such as dynamic PCS adaptation. The types of applications, however, are not limited in this context.

In one embodiment, the receiving node may record the statistic from CPF 1030, and adds the indicated statistic to a vector of recently received statistics from the neighborhood V_{N}. The receiving node may also updates a count A_{N} of the total number of control frames including neighborhood statistics seen in the current statistics interval (T_current). V_{N} and A_{N} can be used to estimate the typical or average statistics values of the network neighborhood during interval T_current, such as total=sum(V_{N}), mean=sum(V_{N})/A_{N}, maximum=max(V_{N}) minimum=min(V_{N}), and so forth. It is worthy to note that each node transmits a control frame only once every T seconds, which means if a node sends out a control frame at time t1 and again at time t2, then t2≧t1+T. This will prevent receiving nodes that cannot reliably distinguish the originator of a control frame from duplicating information from the same node when performing neighborhood estimation. The receiving nodes may not be capable of identifying the source for a control frame since the control frame may not necessarily be tagged with the identification of the originator of the control frame.

In one embodiment, however, it may be desirable to identify the source of a statistic using a source address. If the channel type parameter for control frame 1000 is set to two (2), for example, a source address may be encoded with the statistic of interest. A node receiving the control frame from a node k can update the neighborhood statistics information, and can also update a table with the estimated statistic at node k. For example, the last recorded statistic at node k may comprise S(k) 2ⁿ. For N nodes in the network neighborhood, each node can maintain up to N entries of S(k). In this manner, S(k) can assist the nodes in a network to keep a running estimate for the statistic of interest at each neighbor node k.

Operations for the above systems may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, although the given programming logic may be described herein as being implemented in the above-referenced modules, it can be appreciated that the programming logic may be implemented anywhere within the system and still fall within the scope of the embodiments.

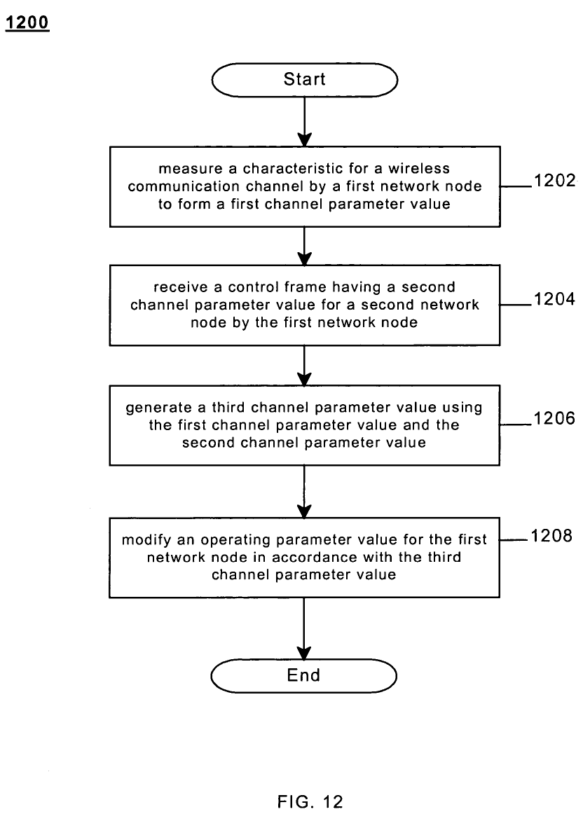

FIG. 12 is one embodiment of programming logic to communicate information using a control frame. FIG. 12 may illustrate a programming logic 1200. Programming logic 1200 may be representative of operations for a system or device described with reference to FIGS. 1-11, such as NEM 960 of wireless device 910 as described with reference to FIG. 9, for example. As shown in FIG. 12, a characteristic for a wireless communication channel may be measured by a first network node to form a first channel parameter value at block 1202. An example of the first channel parameter value may comprise a local PCS threshold for the first network node. A control frame having a second channel parameter value for a second network node may be received by the first network node at block 1204. An example of the second channel parameter value may comprise a local PCS threshold for the second network node. A third channel parameter value may be generated using the first channel parameter value and the second channel parameter value at block 1206. An example of the third channel parameter value may comprise a combination of the local PCS threshold from the first network node and the local PCS threshold for the second network node, a minimum PCS threshold value, a maximum PCS threshold value, and so forth. An operating parameter value for the first network node may be modified in accordance with the third channel parameter value at block 1208. An example of an operating parameter value may comprise the PCS threshold value actually used for packet transmission, which may comprise the third channel parameter value, or the third channel parameter value may be used to derive a global PCS threshold for the entire network.

In one embodiment, a characteristic for a wireless communication channel may be measured at block 1202 by measuring the characteristic to form the first channel parameter value during a first time period. The first channel parameter value may be stored at an end time for the first time period.

In one embodiment, a control frame may be generated to communicate the first channel parameter value measured during the first time period. The control frame with the first channel parameter value may be sent to the second network node during a second time period. The first channel parameter value may be initialized to zero. The characteristic may be measured to form the first channel parameter value during the second time period.

It may be appreciated that to the extent the terms “first,” “second,” and “third” channel parameter values are used with reference to programming logic 1200, these terms are used only to differentiate between different types of channel parameter values, and do not necessarily imply a priority level or temporal order to the channel parameter values.

Although NSP is described above as communicating adaptation information, it may be appreciated that NSP may be used to communicate any type of information between nodes A-C of system 200. For example, the information may comprise any type of characteristic or statistic for a node or its surrounding environment, such as power consumption for a node, processing speeds for a node, idle time for a node, monitoring parameters for critical elements of a node, operating status, location, sensor outputs, and so forth. The type and number of parameters associated with a given node are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

All or portions of an embodiment may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

1. An apparatus, comprising:
a measurement module to measure a characteristic for a wireless communication channel by a first network node to form a first channel parameter value;
a collection module to couple to said measurement module, said collection module to receive said first channel parameter value and a control frame having a second channel parameter value for a second network node, said collection module to use said first channel parameter value and said second channel parameter value to generate a third channel parameter value; and
an adaptation module to couple to said collection module, said adaptation module to modify an operating parameter value for said first network node in accordance with said third channel parameter value.

2. The apparatus of claim 1, wherein said measurement module is arranged to measure said characteristic to form said first channel parameter value during a first time period.

3. The apparatus of claim 2, further comprising a control frame module to couple to said measurement module and said transceiver, with said control frame module to generate a control frame to communicate said first channel parameter value measured during said first time period, and said transceiver to send said control frame with said first channel parameter value to said second network node during a second time period.

4. The apparatus of claim 1, wherein said control frame comprises a frame control field, a parameter type control field, a channel parameter field, and an error checking field.

5. The apparatus of claim 4, wherein said frame control field comprises 2 bytes, said parameter type control field comprises 1 byte, said channel parameter field comprises 7 bytes, and said error checking field comprises 4 bytes.

6. The apparatus of claim 4, wherein said frame control field comprises header information, said parameter type control field comprises a channel type parameter, said channel parameter field comprises a channel parameter, and said error checking field comprises error checking information.

7. A system, comprising:
an omni-directional antenna;
a transceiver to couple to said antenna;
control logic to couple to said transceiver to control communication of information by said transceiver in accordance with at least one operational parameter; and
a network estimate module to couple to said control logic and said transceiver, said network estimate module to receive channel parameter values from multiple nodes within a network from said transceiver, and to modify said operational parameter in accordance with said received channel parameter values.

8. The system of claim 7, wherein said network estimate module comprises:
a measurement module to measure a characteristic for a wireless communication channel by a first network node to form a first channel parameter value;
a collection module to couple to said measurement module, said collection module to receive said first channel parameter value and a control frame having a second channel parameter value for a second network node, said collection module to use said first channel parameter value and said second channel parameter value to generate a third channel parameter value; and
an adaptation module to couple to said collection module, said adaptation module to modify an operating parameter value for said first network node in accordance with said third channel parameter value.

9. The system of claim 7, wherein said control frame comprises a frame control field, a parameter type control field, a channel parameter field, and an error checking field.

10. The system of claim 9, wherein said frame control field comprises 2 bytes, said parameter type control field comprises 1 byte, said channel parameter field comprises 7 bytes, and said error checking field comprises 4 bytes.

11. The system of claim 9, wherein said frame control field comprises header information, said parameter type control field comprises an encoding type value, said channel parameter field comprises a channel parameter identifier and a channel parameter value, and said error checking field comprises error checking information.

12. A method, comprising:
measuring a characteristic for a wireless communication channel by a first network node to form a first channel parameter value;
receiving a control frame having a second channel parameter value for a second network node by said first network node;
generating a third channel parameter value using said first channel parameter value and said second channel parameter value; and
modifying an operating parameter value for said first network node in accordance with said third channel parameter value.

13. The method of claim 12, wherein said measuring comprises:
measuring said characteristic to form said first channel parameter value during a first time period; and
storing said first channel parameter value at an end time for said first time period.

14. The method of claim 13, further comprising:
generating a control frame to communicate said first channel parameter value measured during said first time period;
sending said control frame with said first channel parameter value to said second network node during a second time period;
initializing said first channel parameter value to zero; and
measuring said characteristic to form said first channel parameter value during said second time period.

15. The method of claim 12, wherein said control frame comprises a frame control field, a parameter type control field, a channel parameter field, and an error checking field.

16. The method of claim 15, wherein said frame control field comprises 2 bytes, said parameter type control field comprises 1 byte, said channel parameter field comprises 7 bytes, and said error checking field comprises 4 bytes.

17. The method of claim 15, wherein said frame control field comprises header information, said parameter type control field comprises a channel type parameter, said channel parameter field comprises a channel parameter, and said error checking field comprises error checking information.

18. An article comprising:
a storage medium;
said storage medium including stored instructions that, when executed by a processor, are operable to measure a characteristic for a wireless communication channel by a first network node to form a first channel parameter value, receive a control frame having a second channel parameter value for a second network node by said first network node, generate a third channel parameter value using said first channel parameter value and said second channel parameter value, and modify an operating parameter value for said first network node in accordance with said third channel parameter value.

19. The article of claim 18, wherein the stored instructions, when executed by a processor, perform said measuring using stored instructions operable to measure said characteristic to form said first channel parameter value during a first time period, and store said first channel parameter value at an end time for said first time period.

20. The article of claim 19, wherein the stored instructions, when executed by a processor, are further operable to generate a control frame to communicate said first channel parameter value measured during said first time period, send said control frame with said first channel parameter value to said second network node during a second time period, initialize said first channel parameter value to zero, and measure said characteristic to form said first channel parameter value during said second time period.

21. The article of claim 18, wherein the stored instructions, when executed by a processor, perform said generating using stored instructions operable to generate said control frame with a frame control field, a parameter type control field, a channel parameter field, and an error checking field.

22. The article of claim 18, wherein the stored instructions, when executed by a processor, perform said generating using stored instructions operable to generate said control frame with said frame control field to comprise 2 bytes, said parameter type control field to comprise 1 byte, said channel parameter field to comprise 7 bytes, and said error checking field to comprise 4 bytes.

23. The article of claim 18, wherein the stored instructions, when executed by a processor, perform said generating using stored instructions operable to generate said control frame with said frame control field to comprise header information, said parameter type control field to comprise an encoding type value, said channel parameter field to comprise a channel parameter, and said error checking field to comprise error checking information.
